(19) United States
(12) Patent Application Publication
(10) Pub. No.: US 2010/0046028 A1
(43) Pub. Date: Feb. 25, 2010

(54) HOST APPARATUS, IMAGE FORMING APPARATUS, AND PRINTING DATA PROCESSING METHOD THEREOF

(75) Inventor: Hong-rok WOO, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/510,409

(22) Filed: Jul. 28, 2009

(30) Foreign Application Priority Data
Aug. 22, 2008 (KR) 2008-82484

(51) Int. Cl. G06F 15/00

(52) U.S. Cl. 358/1.15

(57) ABSTRACT

An image forming apparatus for shortening an engine driving start point, includes an interface to receive printing data including a first page of a printable document as rasterized data and page information from a host apparatus; an engine unit to perform printing; and a main controller to print the rasterized data first by driving the engine unit using the page information in response to the printing data received through the interface. Thus, the printing speed is enhanced.

### CROSS-REFERENCE TO RELATED APPLICATIONS

This application claims the benefit of Korean Application No. 10-2008-0082484, filed Aug. 22, 2008, in the Korean Intellectual Property Office, the disclosure of which is incorporated herein by reference.

### BACKGROUND OF THE INVENTION

1. Field of the Invention

Aspects of the present invention relate generally to a host apparatus, an image forming apparatus, and a printing data processing method thereof. More particularly, the present invention relates to a host apparatus, an image forming apparatus, and a printing data processing method for increasing a printing speed.

2. Description of the Related Art

In accordance with advances of electronic technologies, various image forming apparatuses such as printers, scanners, multi-function devices, copiers, and fax machines are prevalently used in the home.

Typically, when a user prints data and transfers the data from a host to a printer, the host converts the data into a printer language interpretable by the printer (e.g., Page Description Language (PDL)) using a printer driver. That is, the printer driver converts the data shown to the user through the host to the printer language. To print data, the user executes the printer driver and the host transfers the printer language generated at the printer driver to the image forming apparatus.

A printer firmware embedded in the image forming apparatus generates output data by interpreting the printer language received from the host. The printing time is delayed because a printer engine is driven when the printer firmware finishes the processing on the first page of the printing data. The printing time is further delayed on account of an engine warming-up time.

In this respect, research on methods for driving the engine upon receiving the printing data from the host is underway. Still, the engine cannot be on stand by indefinitely until the first page of the printing data is actually processed. As a result, it is hard to specify the standby time of the engine.

According to properties of the PDL, since the amount of data in one page to process varies depending on the actual data feature, that is, since it may take several minutes to process a page depending on the user or an application and the printer driver, it is not easy to drive the engine prior to the actual processing of the printing data.

To address those problems, a method for shortening the printer engine driving start time is desirable.

### SUMMARY OF THE INVENTION

Aspects of the present invention provide a host apparatus, an image forming apparatus, and a printing data processing method for raising a printing speed.

In accordance with an exemplary embodiment of the present invention, a host apparatus includes a printing data generator to generate printing data having a first page of a printable document as rasterized data; and an interface to transfer the generated printing data to an image forming apparatus.

According to an aspect of the present invention, the printing data generator may generate the printing data by executing at least one of a printer driver and an application.

According to an aspect of the present invention, the printing data generator may generate page information indicating that the first page of the printable document is the rasterized data, to the printing data.

According to an aspect of the present invention, the page information may include information relating to an engine driving time of the image forming apparatus.

According to an aspect of the present invention, the page information may include Printer Job Language (PJL) data.

According to an aspect of the present invention, the first page of the printable document and other data may be processed in the same printer language or in different printer languages.

According to an aspect of the present invention, other data excluding the first page of the printable document may be non-rasterized data.

In accordance with another exemplary embodiment of the present invention, an image forming apparatus includes an interface to receive printing data including a first page of a printable document as rasterized data and page information from a host apparatus; an engine unit to perform printing; and a main controller to print the rasterized data first by driving the engine unit using the page information in response to the printing data being received through the interface.

According to an aspect of the present invention, the main controller may determine when to drive the engine unit by interpreting the page information.

According to an aspect of the present invention, the page information may indicate that the first page of the printable document is the rasterized data.

According to an aspect of the present invention, other pages excluding the first page of the document to print may be non-rasterized data.

In accordance with yet another exemplary embodiment of the present invention, a data processing method of a host apparatus connected to an image forming apparatus and controlling the image forming apparatus includes generating printing data having a first page of a printable document as rasterized data; and transferring the generated printing data to the image forming apparatus.

According to an aspect of the present invention, the generating of the printing data may be performed in at least one of a printer driver and an application.

According to an aspect of the present invention, the generating of the printing data may generate page information indicating that the first page of the printable document is the rasterized data.

According to an aspect of the present invention, the page information may include information having an engine driving time of the image forming apparatus.

According to an aspect of the present invention, the page information may include Printer Job Language (PJL) data.

According to an aspect of the present invention, the first page and other pages of the printable document may be processed in the same printer language, or in different printer languages.

According to an aspect of the present invention, other pages excluding the first page of the document to print may be non-rasterized data.

According to an aspect of the present invention, the generating of the printing data may include generating the printing data in which a preset page of the printable document is rasterized data.

In accordance with still another exemplary embodiment of the present invention, a printing method of an image forming apparatus includes printing the rasterized data first by driving an image forming apparatus using the page information in response to the image forming apparatus receiving the printing data having the first page of the printable document as the rasterized data and the page information from the host apparatus.

According to an aspect of the present invention, the printing method may further include determining when to drive the engine by interpreting the page information.

According to an aspect of the present invention, the page information may indicate that the first page of the printable document is the rasterized data.

According to an aspect of the present invention, other pages excluding the first page of the printable document may be non-rasterized data.

Therefore, the printing speed can be increased and the engine driving start point can be shortened.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a host apparatus according to an exemplary embodiment of the present invention;

FIG. 2 is a block diagram of an image forming apparatus according to another exemplary embodiment of the present invention;

FIG. 3 is a detailed block diagram of the host apparatus and the image forming apparatus of FIGS. 1 and 2;

FIGS. 4A and 4B illustrate one print job written in one printer language according to an exemplary embodiment of the present invention;

FIG. 5 illustrates a print job written in two printer languages according to another exemplary embodiment of the present invention;

FIG. 6 illustrates one print job written in one printer language according to an exemplary embodiment of the present invention;

FIG. 7 is a flowchart outlining a data processing method of the host apparatus according to an exemplary embodiment of the present invention; and

FIG. 8 is a flowchart outlining a printing method of the image forming apparatus according to another exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

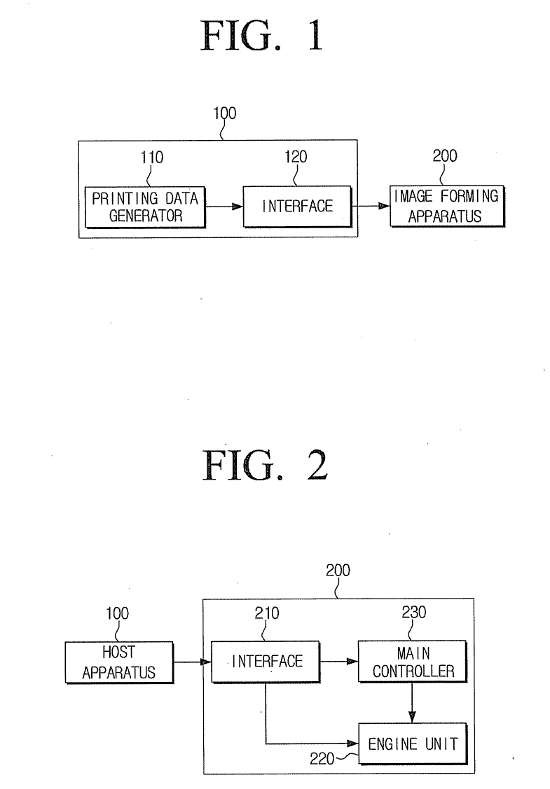

FIG. 1 is a block diagram of a host apparatus according to an exemplary embodiment of the present invention. Herein, the host apparatus 100 is connected to an image forming apparatus 200 to communicate with each other. The host apparatus 100 can be implemented using a personal computer (PC), a notebook computer, a personal digital assistant (PDA), a remote terminal or other similar devices.

The image forming apparatus 200 receives printing data from the host apparatus 100 and carries out the print job. Herein, the print job indicates one printing operation requested from the host apparatus 100. Namely, a print command by the user corresponds to one print job. Alternatively, depending on the number of languages creating the printing data, one print job may be one or more than two jobs, which will be explained in detail.

The host apparatus of FIG. 1 includes a printing data generator 110 and an interface 120.

The printing data generator 110 generates printing data including the rasterized first page of a document to print. Herein, the rasterization converts text and graphic to pixels or dots printable by the image forming apparatus 200 onto the paper.

The printing data generator 110 rasterizes the first page of the document to print and creates the other pages as non-rasterized data, for example, using a Page Description Language (PDL).

More specifically, the printing data generator 110 can convert the first page of the printable document directly in a bitmap format, without using the printer language, and convert the other pages in the PDL readable by the image forming apparatus 200. The conversion in the bitmap format can be carried out through GDI emulation, PCL5e emulation, and rendering.

Thus, it is possible to shorten the time taken for the image forming apparatus 200 to process the data of a preset number of pages.

While only the first page of the printable document is rasterized, a preset page may be rasterized. In some cases, a user can determine the number of pages to be rasterized, using an input unit (not shown).

Herein, the PDL is a language representing contents of the printing data. Namely, the PDL describes an image to print. Rather than a human, an application such as Illustrator describes the image for the image forming apparatus. There are various PDLs based on the property of the print job and the properties of the image forming apparatus, for example, PostScript, Printer Command Language (PCL), PCL-GUI, PCL XL, HPGL, ESC/P2, PCL5e, ESC/PAGE, and ESC/PAGE-COLOR, which are now described in brief.

PCL was developed by Hewlett Packard (HP) and is widely used as a standard printer language with levels 1 through 6. For example, PCL5 adds a scalable font function and a vector graphic function to PCL4 to address blurring or coarse characters when scaling up or down the characters. PCL5 is used as a powerful language to support more universal printing environments including line printers and page printers.

PostScript, released by Adobe in 1982, is a PDL widely used in desktop publishing and electronic publishing. Thanks to resolution independence and device independence of PostScript, characters or images created with PostScript are not blurred or compromised even when scaling-up characters or image size, thus producing high-quality printing.

Additionally, ESC/P2, ESC/PAGE, and ESC/PAGE-COLOR are PDLs used in recent printers made by Epson.

When generating the printing data, the printing data generator 110 can include, in the printing data, page information indicating that the first page of the printable document is rasterized data, to the printing data.

The page information can include information relating to the engine driving time of the image forming apparatus 200.

Herein, the page information can include Printer Job Language (PJL) information.

PJL is a language describing the print job, including jobs processed by the image forming apparatus 200 in addition to the pages to print.

The printing data generator 110 can process the first page and the other pages of the printable document in the same printer language. Alternatively, the printing data generator 110 may process the first page and the other pages of the printable document in different printer languages, which will be illustrated in detail.

The interface 120 transfers the data generated at the printing data generator 110 to the image forming apparatus 200. The interface 120 can employ various interface formats, for example, parallel port, serial port, Universal Serial Bus (USB), network, local, Institute of Electrical and Electronics Engineers (IEEE) 1394 (serial bus interface standard), Bluetooth, or other similar interface formats.

FIG. 2 is a block diagram of the image forming apparatus 200 according to another exemplary embodiment of the present invention. The image forming apparatus 200 of FIG. 2 includes an interface 210, an engine unit 220, and a main controller 230.

The image forming apparatus 200 can be implemented using a printer, a scanner, a copier, a fax machine, and a multi-function device incorporating at least two of the printer, the scanner, the copier, and the fax machine.

The interface 210 communicates with the host apparatus 100 of FIG. 1. The interface 210 employs various interface formats, for example, parallel port, serial port, USB, network, local, IEEE 1394 (serial bus interface standard), Bluetooth, or other similar interface formats.

The interface 210 receives the printing data including the rasterized first page of the printable document and the page information from the host apparatus 100 connected over the network or connected locally.

The engine unit 220 performs the scanning job, the fax job, the copying job, and the printing job under the control of the main controller 230.

When receiving the printing data through the interface 210, the main controller 230 drives the engine unit 220 to print the rasterized printing data first. Herein, the driving of the engine unit 220 supplies the driving power to components of the engine unit 220 and keeps them stand by. More particularly, the engine unit 220 enters a printable mode by driving a developing unit, a Laser Scanning Unit (LSU), a transfer unit, an Optical Photo Conductive (OPC) drum, a charging unit, a cleaning unit, and a fixing unit for the printing job.

The main controller 230 can process the pages other than the rasterized first page into a printable form.

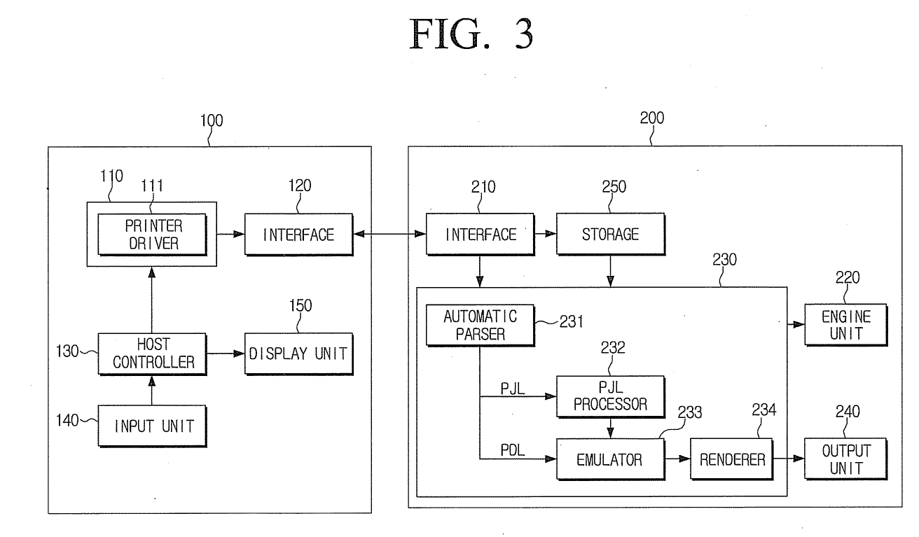

The main controller 230 can determine when to drive the engine unit 220 by interpreting the page information of the printing data, which will be described in further detail in reference to FIG. 3.

FIG. 3 is a detailed block diagram of the host apparatus 100 and the image forming apparatus 200 of FIGS. 1 and 2. The elements of FIG. 3, which perform the same operations as in FIGS. 1 and 2, shall not be described for brevity.

The host apparatus 100 of FIG. 3 includes the printing data generator 110, the interface 120, a host controller 130, an input unit 140, and a display unit 150. In addition, the host apparatus 100 can further include a Read Only Memory (ROM) and a Random Access Memory (RAM).

The printing data generator 110 can generate the printing data by executing either a printer driver 111, an application (not shown) or both to generate documents. To simplify the description, it is assumed that the printing data generator 110 is implemented using the printer driver 111.

The printer driver 111 converts the document written in the application (not shown) to a language interpretable by the image forming apparatus 200. The printer driver 111 provides a printing screen of the document created in the application. In particular, the printer driver 111 converts document information including the printer language type, the file name, the document structure, and the print options of the printing data, to the PJL in the header of the printing data.

The host controller 130 controls the operations of the host apparatus 100. For instance, the host controller 130 can control the printer driver 111 to create the printing data.

The input unit 140 forwards a key input signal according to the user's key manipulation to the host controller 130. For example, the input unit 140 can receive a print command from the user. The input unit 110 can employ a keyboard, a mouse, a touch panel, and so forth.

The display unit 150 can be a display device such as a general monitor. Under the control of the host controller 130, the display unit 150 displays the operation state of the host apparatus 100.

For instance, when the print command is received through the input unit 140, the display unit 150 can display the data to print in the screen under the control of the host controller 130.

The image forming apparatus 200 includes the interface 210, the engine unit 220, the main controller 230, and an output unit 240.

The main controller 230 controls the operations of the image forming apparatus 200 according to the control program. The main controller 230 can include a data processor 230′ which interprets and processes the printing data received through the interface 210.

The data processor 230′ can include an automatic parser 231, a PJL processor 232, an emulator 233, and a renderer 234.

In various implementations of the present invention, the printing data can include only PJL data and PDL data, or include PJL data, GDI data, and PDL data. Herein, the structure of the data processor 230′ is illustrated based on the printing data including only the PJL data and PDL data. For the printing data including the PJL data, the GDI data, and the PDL data, the main controller 230 may further include a GDI processor (not shown) for processing the GDI data.

The automatic parser 231 distinguishes the type of the printing data fed through the interface 210, that is, distinguishes the PJL data and the PDL data. The automatic part 231 outputs the PJL data to the PJL processor 232, and outputs the PDL data to the emulator 233. The PJL processor 232 analyzes PJL commands of the PJL data using a PJL parser and sets printing control jobs. The emulator 233 properly emulates according to the PDL data. The renderer 234 renders the emulation data output from the emulator 233.

The output unit 240 produces the data output from the renderer 234 onto a recording medium.

When the PJL processor 232 analyzes the PJL commands and detects the page information indicating the first page of the printing data is rasterized, the main controller 230 controls to drive the engine unit 220. Thus, the image forming apparatus 200 can reduce the engine driving time. The main controller 230 may control to drive the engine unit 220 when the analysis of the PJL commands is completed. In some cases, the main controller 230 may suitably determine the engine driving time.

The storage 250 can store operating program information of the image forming apparatus 200 and the printing data received through the interface 210. Alternatively, when the printing data stored to the storage 250 is output and the first page and the other pages of the printable document are processed in the same printer language, the printing data can be stored as a single job.

When the first page and the other pages of the printable document are processed in the different printer languages, the storage 250 stores the printing as two separate jobs.

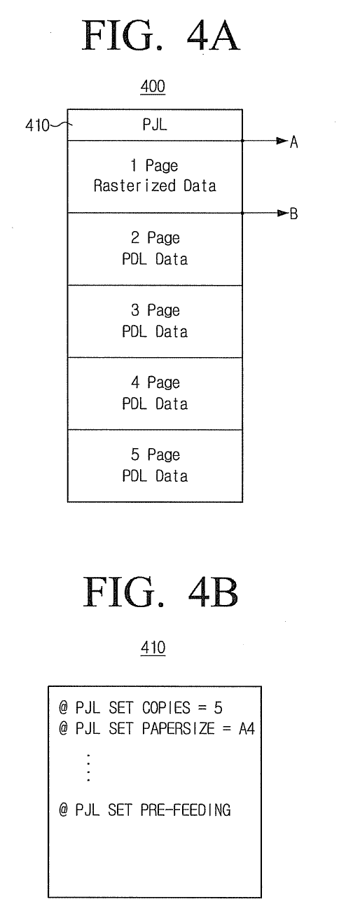

FIGS. 4A and 4B illustrate one print job written in one printer language according to an exemplary embodiment of the present invention.

In FIG. 4A, the first page of the printing data is the rasterized data and the other pages are the PDL data.

The PJL 410 attached to the header of the printing data 400 includes the page information “PJL SET PRE-FEEDING” indicating of the rasterized first page of the printing data as shown in FIG. 4B. Hence, the engine can be driven at the time point “A” where the PJL is interpreted. Herein, the data processing time A˜B of the first page which is the rasterized data, is fixed.

Yet, since the rasterized data is created with the PDL language, the printing data can be written with a single language (such as PDL). Accordingly, even when the image forming apparatus 200 supports only one language, the printing data can be applied still.

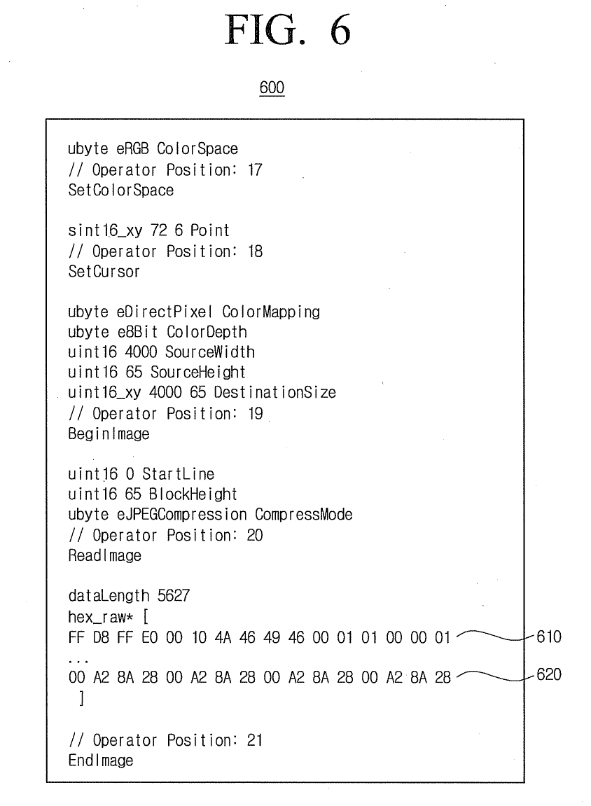

In this case, the detailed printer language is shown in FIG. 6, where reference numbers 610 and 620 indicate the data of the rasterized first page. Note that this is an example and the actual size may differ depending on the data size and the compression ratio.

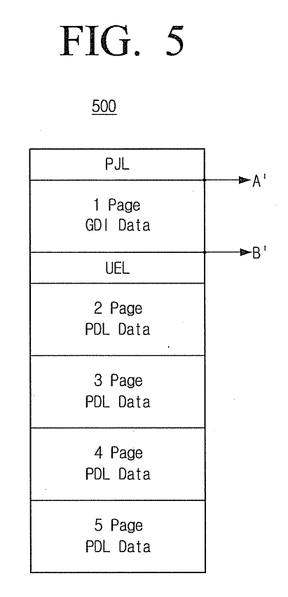

FIG. 5 illustrates a print job written in two printer languages according to another exemplary embodiment of the present invention.

In FIG. 5, the first page of the printing data is in GDI (or PCL5e) data and the other pages are the PDL data. The rasterized GDI data is transferred to the image forming apparatus 200. Based on 4 bits/pixel, the data transfer rate can be raised, compared to the rasterized PDL data (24 bit/pixel in FIG. 4). However, since the first page of the printing data is created in the different language from the other pages, the image forming apparatus 200 should support two different languages. Universal Exit Language (UEL) command suffixed to the GDI data indicates the end of the current printer language.

As in FIG. 4B, the PJL added to the header of the printing data 500 includes page information “PJL SET PRE-FEEDING” indicative of the rasterized first page of the printing data. The engine is driven at the time point “A′” where the PJL is interpreted. The data processing time of the first page is fixed to A′˜B′.

While the conventional printer driver is inapplicable to the printing data of FIG. 4, the conventional printer driver is applicable to the printing data of FIG. 5. In other words, the printing data of FIG. 5 can be created using the conventional printer driver of the GDI based printer and the conventional printer driver of the PDL based printer.

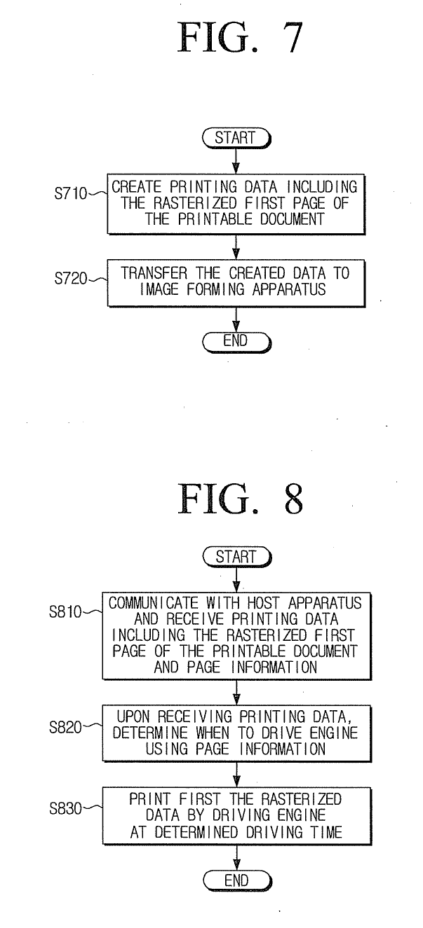

FIG. 7 is a flowchart outlining a data processing method of the host apparatus according to an exemplary embodiment of the present invention.

According to the data processing method of the host apparatus connected to the image forming apparatus to control the image forming apparatus in FIG. 7, the host apparatus creates the printing data including the rasterized first page of the printable document in operation S710. Next, the host apparatus transfers the created data to the image forming apparatus in operation S720.

Herein, the printing data can be created by executing either the printer driver, the application or both.

The printing data can include the page information indicative of the rasterized first page of the printable document.

The page information can include the information relating to the engine driving time of the image forming apparatus.

The page information can include the PJL information.

The first page and the other pages of the printable document can be processed in the same printer language.

Alternatively, the first page and the other pages of the printable document may be processed in the different printer languages.

FIG. 8 is a flowchart outlining a printing method of the image forming apparatus according to another exemplary embodiment of the present invention.

The image forming apparatus communicates with the host apparatus and receives the printing data including the rasterized first page of the printable document and the page information in operation S810.

Upon receiving the printing data, the image forming apparatus determines when to drive the engine in operation S820.

By driving the engine at the determined driving time in operation S820, the image forming apparatus first prints the rasterized printing data in operation S830.

Herein, the page information can indicate that the first page of the printable document is rasterized.

The other pages, excluding the first page of the printable document, can be the non-rasterized data.

Therefore, the printing speed can be raised by shortening the engine driving start point.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A host apparatus comprising:
a printing data generator to generate printing data having a first page of a printable document as rasterized data; and
an interface to transfer the generated printing data to an image forming apparatus.

2. The host apparatus of claim 1, wherein the printing data generator generates the printing data by executing at least one of a printer driver and an application.

3. The host apparatus of claim 1, wherein the printing data generator generates page information indicating that the first page of the printable document is the rasterized data.

4. The host apparatus of claim 3, wherein the page information comprises information relating to an engine driving time of the image forming apparatus.

5. The host apparatus of claim 3, wherein the page information comprises Printer Job Language (PJL) data.

6. The host apparatus of claim 1, wherein the first page of the printable document and other data are processed in the same printer language or in different printer languages.

7. The host apparatus of claim 1, wherein other data excluding the first page of the printable document are non-rasterized data.

8. An image forming apparatus comprising:
an interface to receive printing data including a first page of a printable document as rasterized data and page information from a host apparatus;
an engine unit to perform printing; and
a main controller to print the rasterized data first by driving the engine unit using the page information in response to the printing data being received through the interface.

9. The image forming apparatus of claim 8, wherein the main controller determines when to drive the engine unit by interpreting the page information.

10. The image forming apparatus of claim 8, wherein the page information indicates that the first page of the printable document is the rasterized data.

11. The image forming apparatus of claim 8, wherein other pages excluding the first page of the printable document are non-rasterized data.

12. A data processing method of a host apparatus connected to an image forming apparatus and controlling the image forming apparatus, the method comprising:
generating printing data having a first page of a printable document as rasterized data; and
transferring the generated printing data to the image forming apparatus.

13. The data processing method of claim 12, wherein the generating of the printing data is performed in at least one of a printer driver and an application.

14. The data processing method of claim 12, wherein the generating of the printing data generates page information indicating that the first page of the printable document is the rasterized data.

15. The data processing method of claim 14, wherein the page information comprises information having an engine driving time of the image forming apparatus.

16. The data processing method of claim 14, wherein the page information comprises Printer Job Language (PJL) data.

17. The data processing method of claim 12, wherein the first page and other pages of the printable document are processed in the same printer language, or in different printer languages.

18. The data processing method of claim 12, wherein other pages excluding the first page of the printable document are non-rasterized data.

19. The data processing method of claim 12, wherein the generating of the printing data comprises generating the printing data in which a preset page of the printable document is rasterized data.

20. A printing method of an image forming apparatus, the method comprising:
printing the rasterized data first by driving an engine of the image forming apparatus using the page information in response to the image forming apparatus receiving the printing data having the first page of the printable document as the rasterized data and the page information from the host apparatus.

21. The printing method of claim 20, further comprising:
determining when to drive the engine by interpreting the page information.

22. The printing method of claim 20, wherein the page information indicates that the first page of the printable document is the rasterized data.

23. The printing method of claim 20, wherein other pages excluding the first page of the printable document are non-rasterized data.
